(19) United States
(12) Patent Application Publication
(10) Pub. No.: US 2026/0012280 A1
(43) Pub. Date: Jan. 8, 2026

(54) OPTICAL TRANSMISSION APPARATUS AND OPTICAL TRANSMISSION METHOD

(71) Applicant: NIPPON TELEGRAPH AND TELEPONE CORPORATION, Tokyo (JP)

(72) Inventors: Shin KANEKO, Musashino-shi (JP); Tomoaki YOSHIDA, Musashino-shi (JP); Naotaka SHIBATA, Musashino-shi (JP); Takuya KANAI, Musashino-shi (JP); Junichi KANI, Musashino-shi (JP)

(73) Assignee: NIPPON TELEGRAPH AND TELEPONE CORPORATION, Tokyo (JP)

(21) Appl. No.: 18/992,240

(22) PCT Filed: Jul. 12, 2022
(86) PCT No.: PCT/JP2022/027359

§ 371 Date: Jan. 8, 2025

(51) Int. Cl. H04J 14/02

(52) U.S. Cl. CPC H04J 14/0212

(57) ABSTRACT

An optical transmission device which transmits an optical signal between a communication terminal device and a network, without converting the optical signal into an electric signal, the optical transmission device including: a plurality of multiplexing/demultiplexing units which input and output the optical signal to and from the communication terminal device connected to an own device; a plurality of wavelength multiplexing separation units which input and output the optical signal to and from a network connected to the own device; an upstream signal demultiplexing unit which outputs the optical signal in an upstream direction, which is output from the multiplexing/demultiplexing unit, to an electric processing unit that executes predetermined electric processing on the optical signal; and an upstream signal multiplexing unit which outputs the optical signal in the upstream direction subjected to the electric processing by the electric processing unit to the predetermined wavelength multiplexing separation unit.

### TECHNICAL FIELD

The present invention relates to an optical transmission apparatus and an optical transmission method.

### BACKGROUND ART

Communication networks of the related art are generally made up of access, metro, and core networks, and have an architecture that connects these in a hierarchical manner. When traffic passes from the access to the metro network, optical signals are first converted into electrical signals at a boundary therebetween. Further, line concentration and multiplexing are performed to provide services to more users in a wider band optical path. The same also applies to a case where traffic passes from the metro to the core network. Thus, it is possible to achieve economical efficiency by sharing facilities between users and sharing facilities between services.

On the other hand, a line band per user and a line band per service are restricted. Therefore, when transmitting large-capacity data such as a high-definition video image, data compression processing is required and a large delay occurs. In addition, a delay and a jitter occurs due to queuing processing of packets and frames at electric line concentration points and multiple points.

On the other hand, a network configuration has been proposed in which an electric termination of an optical signal, which has been provided between hierarchies in the conventional network, is not required. In this network configuration, an access node is disposed at a boundary between the access and the metro. The access node has a function of distributing the optical signal depending on a route of an optical path in which a device which is a destination of the optical signal is set as an end point. With such a configuration, optical through, folding, extraction and insertion are realized, and an End-End optical path having a large capacity and a low delay can be provided between arbitrary points. The optical through is a function of transmitting the optical signal beyond the boundary between the access and the metro. The folding is a function of optically coupling user devices accommodated in the same access node. The extraction and insertion is a function for realizing electric processing when it is required at the reproduction relay and wavelength conversion and the network layer and service layer.

### CITATION LIST

### Non Patent Literature

Non Patent Literature 1: “Open All-Photonic Network Functional Architecture,” Version 1.0, Innovative Optical Wireless Network (IOWN) Global Forum, January 2022, [Online] https://iowngf.org/technology/Non
Patent Literature 2: S. Gringeri, B. Basch, V. Shukla, R. Egorov, and T. Xia, “Flexible architectures for optical transport nodes and networks,” IEEE Communications Magazine, vol. 48, No. 7, pp. 40-50, 2010.
Non Patent Literature 3: Takuya Kanai, Kazuaki Honda, Yasunari Tanaka, Shin Kaneko, Kazutaka Hara, Junichi Kani, Tomoaki Yoshida, “Photonic Gateway for All-Photonics Network,” IEICE General Conference, B-8-20, March 2021

### SUMMARY OF INVENTION

### Technical Problem

One of optical nodes widely used in a metro network or the like in a conventional optical communication system is an optical transmission device 90 such as a reconfigurable optical add/drop multiplexer (ROADM). The optical transmission device 90 realizes efficient transmission of traffic by connecting a plurality of bases. FIG. 7 is a diagram showing a configuration example of a conventional optical transmission system. An optical transmission device 90 included in the optical transmission system shown in FIG. 7 includes a plurality of multiplexing/demultiplexing units 91, a plurality of wavelength multiplexing separation units 92, and a control unit 99.

The multiplexing/demultiplexing unit 91 is connected to a plurality of transponders 30 and the plurality of wavelength multiplexing separation units 92. The multiplexing/demultiplexing unit 91 outputs an optical signal which is input from the transponder 30 toward the wavelength multiplexing separation unit 92 connected to a path that accommodates an optical path whose transponder 30 is the end point. The multiplexing/demultiplexing unit 91 wavelength-multiplexes optical signals sharing the route. The multiplexing/demultiplexing unit 91 outputs the optical signal which is input from the wavelength multiplexing separation unit 92 from a port connected to the transponder 30 which is the destination of the optical signal. The multiplexing/demultiplexing unit 91 is implemented, by using an M×N multicast switch, a Wavelength Selective Switch (WSS) of M×N, a combination of a 1×M WSS and a 1×N WSS, and the like. The MN multicast switch is made up of, for example, M 1×N optical splitters/couplers and N M×1 optical switches.

The wavelength multiplexing separation unit 92 is connected to the plurality of multiplexing/demultiplexing units 91 and the plurality of other wavelength multiplexing separation units 92. The wavelength multiplexing separation unit 92 wavelength-multiplexes wavelength-multiplexed optical signals which are input from each multiplexing/demultiplexing unit 91 and each another wavelength multiplexing separation unit 92. The wavelength multiplexing separation unit 92 outputs the wavelength-multiplexed optical signal from the network side port. The wavelength multiplexing separation unit 92 outputs the optical signal which is input from the network side port, toward the multiplexing/demultiplexing unit 91 and another wavelength multiplexing separation unit 92, depending on the route of the optical path in which the transponder 30, which is the destination of the optical signal, is an end portion. The wavelength multiplexing separation unit 92 may be mounted using, for example, a Wavelength Cross Connect (WXC) made up of WSS.

The control unit 99 controls operations of the multiplexing/demultiplexing unit 91 and the wavelength multiplexing separation unit 92. The control unit 99 may allocate wavelengths to the transponder 30. In the optical transmission device 90 such as a ROADM, the optical signal which is input from the transponder 30 is output from the network side port of one of the wavelength multiplexing separation unit 92 without being subjected to optical/electrical conversion. The optical signal which is input from the network side port of the wavelength multiplexing separation unit 92 is output toward any one of the transponder 30 without being subjected to optical/electrical conversion. Therefore, when such an optical transmission device 90 is used as an access node, extraction and insertion cannot be realized. Therefore, processing such as reproduction relay, wavelength conversion, and electric processing in the network layer/service layer cannot be realized.

In view of the above-mentioned circumstances, an object of the present invention is to provide a technique that enables electric processing to be performed on a signal, in an optical transmission system that transmits a signal without performing the optical/electrical conversion.

### Solution to Problem

An aspect of the present invention is an optical transmission device which transmits an optical signal between a communication terminal device and a network, without converting the optical signal into an electric signal, the optical transmission device including: a plurality of multiplexing/demultiplexing units which input and output the optical signal to and from the communication terminal device connected to an own device; a plurality of wavelength multiplexing separation units which input and output the optical signal to and from a network connected to the own device; an upstream signal demultiplexing unit which outputs the optical signal in an upstream direction, which is output from the multiplexing/demultiplexing unit, to an electric processing unit that executes predetermined electric processing on the optical signal; and an upstream signal multiplexing unit which outputs the optical signal in the upstream direction subjected to the electric processing by the electric processing unit to the predetermined wavelength multiplexing separation unit.

An aspect of the present invention is an optical transmission device which transmits an optical signal between a communication terminal device and a network, without converting the optical signal into an electric signal, the optical transmission device including: a plurality of multiplexing/demultiplexing units which input and output the optical signal to and from the communication terminal device connected to an own device; a plurality of wavelength multiplexing separation units which input and output the optical signal to and from a network connected to the own device; a downstream signal demultiplexing unit which outputs the optical signal in a downstream direction, which is output from the wavelength multiplexing separation unit, to an electric processing unit that executes predetermined electric processing on the optical signal; and a downstream signal multiplexing unit which outputs the optical signal in the downstream direction subjected to the electric processing by the electric processing unit to the predetermined multiplexing/demultiplexing unit.

An aspect of the present invention is an optical transmission method which transmits an optical signal between a communication terminal device and a network, without converting the optical signal into an electric signal, the optical transmission method including: a plurality of multiplexing/demultiplexing steps of inputting and outputting the optical signal to and from the communication terminal device connected to an own device, by a multiplexing/demultiplexing unit; a plurality of wavelength multiplexing separation steps of inputting and outputting the optical signal to and from a network connected to the own device, by a wavelength multiplexing separation unit; an upstream signal demultiplexing step of outputting the optical signal in an upstream direction, which is output from the multiplexing/demultiplexing unit, to an electric processing unit that executes predetermined electric processing on the optical signal, by an upstream signal demultiplexing unit; and upstream signal multiplexing step of outputting the optical signal in the upstream direction subjected to the electric processing by the electric processing unit to the predetermined wavelength multiplexing separation unit, by a upstream signal multiplexing unit.

An aspect of the present invention is an optical transmission method which transmits an optical signal between a communication terminal device and a network, without converting the optical signal into an electric signal, the optical transmission method including: a plurality of multiplexing/demultiplexing steps of inputting and outputting the optical signal to and from the communication terminal device connected to an own device, by a multiplexing/demultiplexing unit; a plurality of wavelength multiplexing separation steps of inputting and outputting the optical signal to and from a network connected to the own device, by a wavelength multiplexing separation unit; a downstream signal demultiplexing step of outputting the optical signal in a downstream direction, which is output from the wavelength multiplexing separation unit, to an electric processing unit that executes predetermined electric processing on the optical signal, by a downstream signal demultiplexing unit; and a downstream signal multiplexing process of outputting the optical signal in the downstream direction subjected to the electric processing by the electric processing unit to the predetermined multiplexing/demultiplexing unit, by a downstream signal multiplexing unit.

### Advantageous Effects of Invention

According to the present invention, in an optical transmission system for transmitting a signal without performing the optical/electrical conversion, electric processing can be performed on the signal.

### BRIEF DESCRIPTION OF DRAWINGS

FIG. 1 is a diagram showing a configuration example of a conventional optical transmission system m.

FIG. 2 is a diagram showing a configuration example of the conventional optical transmission system n.

FIG. 3 is a diagram showing the configuration of an optical transmission system 100a in a first embodiment of the present invention.

FIG. 4 is a flowchart showing the operation of the optical transmission system 100a in the first embodiment of the present invention.

FIG. 5 is a diagram showing a configuration of an optical transmission system 100b in a second embodiment of the present invention.

FIG. 6 is a flowchart showing the operation of the optical transmission system 100b in the second embodiment of the present invention.

FIG. 7 is a diagram showing a conventional optical transmission system.

### DESCRIPTION OF EMBODIMENTS

Hereinafter, an optical transmission apparatus and an optical transmission method according to an embodiment of the present invention will be described with reference to the drawings.

In order to make the features of the optical transmission apparatus and optical transmission method in the embodiment of the present invention more easily understandable, the related art based on the technique described in NPL 3 as a comparison object will be described first. NPL 3 describes a configuration of an optical transmission device which realizes an extraction function and an insertion function by expanding the multiplexing/demultiplexing unit.

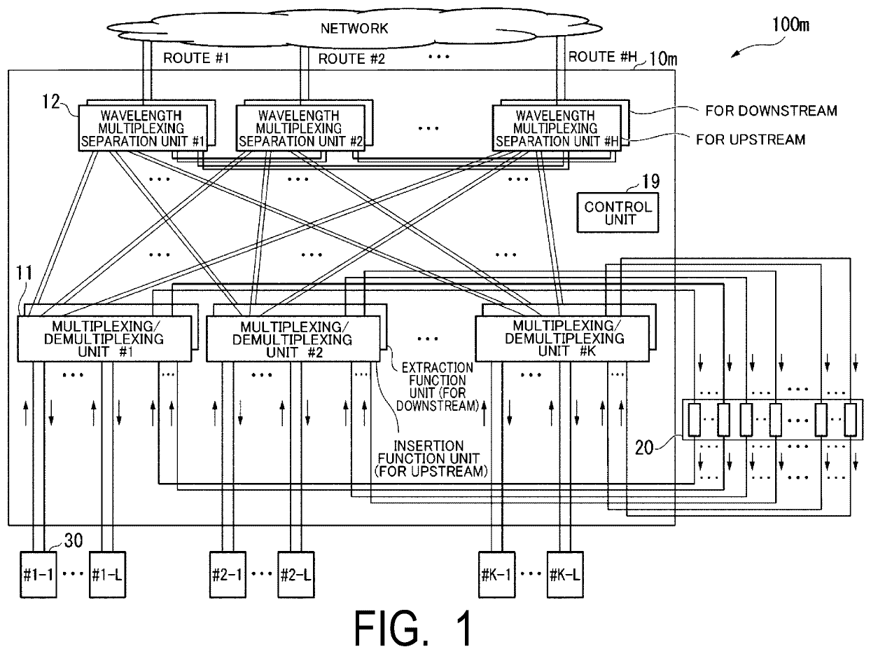

FIG. 1 is a diagram showing a configuration example of a conventional optical transmission system 100m. The optical transmission system 100m includes an optical transmission device 10m and an electric processing unit 20. The optical transmission device 10m and the electric processing unit 20 are connected to mutually input and output the optical signals. The optical transmission device 10m is connected to the network and the plurality of transponders 30. The optical transmission device 10m is connected to another optical transmission device (not shown) via a network made up of optical fibers.

In FIG. 1, a network is located on an upper side of the optical transmission device 10m. When a position relatively close to the network is pointed, it is described as “network side”. A transponder 30 is located on a lower side of the optical transmission device 10m. When the position is relatively close to the transponder 30 side, the position is described as “transponder side”.

The conventional optical transmission system 100m shown in FIG. 1 is configured to realize electric processing for an optical signal in the upstream direction from a lower side (transponder side) to an upper side (network side) in the drawing.

The optical transmission device 10m includes a plurality of (K) multiplexing/demultiplexing units 11, a plurality of (H) wavelength multiplexing separation units 12, and a control unit 19. K and H are each integers of 2 or more. K and H may be the same value or different values.

The multiplexing/demultiplexing unit 11 is connected to a plurality of (L) transponders 30, a plurality of (H) wavelength multiplexing separation units 12, and an electric processing unit 20 to mutually input and output the optical signals.

For upstream traffic from the lower side to the upper side in the drawing, the multiplexing/demultiplexing unit 11 outputs an optical signal, which is input from the transponder 30, toward the wavelength multiplexing separation unit 12 or the electric processing unit 20. At this time, the wavelength multiplexing separation unit 12 to be an output destination is the wavelength multiplexing separation unit 12 that is connected to a route which accommodates an optical path in which the transponder 30 which is a transmission source of an optical signal is set as an end point. The multiplexing/demultiplexing unit 11 wavelength-multiplexes the optical signals sharing the route and outputs them. The multiplexing/demultiplexing unit 11 outputs the optical signal from the network side port to the electric processing unit 20, when the electric processing by the electric processing unit 20 is required for the output optical signal. With such a configuration, the extraction function is realized.

For a downstream traffic from the upper side to the lower side in the drawing, the multiplexing/demultiplexing unit 11 outputs the optical signal, which is input from the wavelength multiplexing separation unit 12, toward the transponder 30. At this time, the multiplexing/demultiplexing unit 11 outputs the optical signal from a port to which the transponder 30 which is a destination of the optical signal to be output is connected.

The multiplexing/demultiplexing unit 11 may be constituted by, for example, using an M×N multicast switch including M 1×N optical splitters/couplers and N M×1 optical switches. The multiplexing/demultiplexing unit 11 may be configured using, for example, a wavelength selective switch (WSS) of M×N. The multiplexing/demultiplexing unit 11 may be configured, by using a device in which a WSS of 1×M and a WSS of 1×N are combined.

The wavelength multiplexing separation unit 12 is connected to a plurality of (K) multiplexing/demultiplexing units 11 and a plurality of (H−1) other wavelength multiplexing separation units 12 to mutually input and output the optical signals. The wavelength multiplexing separation unit 12 wavelength-multiplexes the wavelength-multiplexed optical signals, which are input from the multiplexing/demultiplexing unit 11 and another wavelength multiplexing separation unit 12, and outputs the multiplexed optical signals to a network from a network side port.

The wavelength multiplexing separation unit 12 outputs the optical signal, which is input from the network side port, toward the multiplexing/demultiplexing unit 11 or another wavelength multiplexing separation unit 12. At this time, the wavelength multiplexing separation unit 12 selects the multiplexing/demultiplexing unit 11 or the wavelength multiplexing separation unit 12 to be an output destination, depending on the route of the optical path in which the transponder 30 to be a destination of the output optical signal is set as an end point. The wavelength multiplexing separation unit 12 may be constituted by, for example, using a WSS.

The control unit 19 is constituted by a processor such as a central processing unit (CPU) and a memory. The control unit 19 may be operated by executing a program with a processor. The control unit 19 controls the operations of the multiplexing/demultiplexing unit 11 and the wavelength multiplexing separation unit 12. For example, the control unit 19 may control a connection relationship between the ports in the multiplexing/demultiplexing unit 11. The control unit 19 may allocate wavelengths to the transponder 30.

The electric processing unit 20 is connected to a plurality (K) of multiplexing/demultiplexing units 11. The electric processing unit 20 performs electric processing on the optical signal that is output from the multiplexing/demultiplexing unit 11 for the upstream traffic. Specific examples of the electric processing executed by the electric processing unit 20 include reproduction relay, wavelength conversion, electric processing in a network layer, electric processing in a service layer, and the like. The electric processing unit 20 outputs the optical signal subjected to the electric processing to the multiplexing/demultiplexing unit 11 of the input source.

In this way, the optical signal in the upstream direction that is input from the network side port of the multiplexing/demultiplexing unit 11 to the electric processing unit 20 is electrically processed by the electric processing unit 20, and then input to the transponder side port of the multiplexing/demultiplexing unit 11 which has input the optical signal to the electric processing unit 20. With such a configuration, the insertion function is realized.

The optical signal in the upstream direction that is input from the network side port of the multiplexing/demultiplexing unit 11 to the electric processing unit 20 may be input to the transponder side port of the multiplexing/demultiplexing unit 11 different from the multiplexing/demultiplexing unit 11 that has output the optical signal to the electric processing unit 20, after electric processing is performed by the electric processing unit 20.

The multiplexing/demultiplexing unit 11 outputs the optical signal that is input from the electric processing unit 20 toward the wavelength multiplexing separation unit 12. At this time, the wavelength multiplexing separation unit 12 to be an output destination is a wavelength multiplexing separation unit 12 that is connected to a route for accommodating an optical path in which the transponder 30 which is a transmission source of the optical signal is set as an end point.

In FIG. 1, the plurality of optical signals that are input to the electric processing unit 20 are output from different ports, but the plurality of input optical signals may be output from the same port after the electric processing is performed. For example, when a Muxponder function for multiplexing a plurality of signals and outputting them as a high-speed optical signal is mounted on the electric processing unit 20, the plurality of input optical signals are output from the same port.

In the optical transmission system 100m shown in FIG. 1, the optical signal in the upstream direction and the optical signal in the downstream direction flow through different optical fiber core wires. However, there may be a section in which each optical signal flows through the same optical fiber core wire.

When the electric processing unit 20 converts the wavelength of the optical signal input to itself into a wavelength different from the wavelength of the optical signal output from the transponder 30 and outputs the optical signal, even if the electric processing unit 20 outputs the optical signal to the same multiplexing/demultiplexing unit 11 as the multiplexing/demultiplexing unit 11 to which the optical signal is input from the transponder 30, no wavelength collision occurs. Therefore, even in a Contention type configuration in which the multiplexing/demultiplexing unit 11 does not allow input of the optical signal of the same wavelength to different ports, the electric processing unit 20 can output the optical signal to the same multiplexing/demultiplexing unit 11 as the multiplexing/demultiplexing unit 11 to which the optical signal is input from the transponder 30. At this time, the wavelength of the optical signal output from the electric processing unit 20 is different from the wavelength of the optical signal input from the transponder 30 to the multiplexing/demultiplexing unit 11 or the wavelength of the other optical signal input from the electric processing unit 20 to the multiplexing/demultiplexing unit 11.

In the configuration of the conventional optical transmission system 100m shown in FIG. 1, it is necessary to secure a port used for the insertion function (hereinafter referred to as “inserting port”) on the transponder side port of the multiplexing/demultiplexing unit 11. Here, when the optical signal output from the electric processing unit 20 is input to the multiplexing/demultiplexing unit 11 without wavelength multiplexing, there is a need for the same number of inserting ports as the number of optical paths to be distributed to the electric processing unit 20. When optical signals output from the electric processing unit 20 are wavelength-multiplexed and input to the multiplexing/demultiplexing unit 11 for each route for accommodating the optical path through which the optical signals output from the electric processing unit 20 are transmitted, inserting ports of the same number as the number of paths are required.

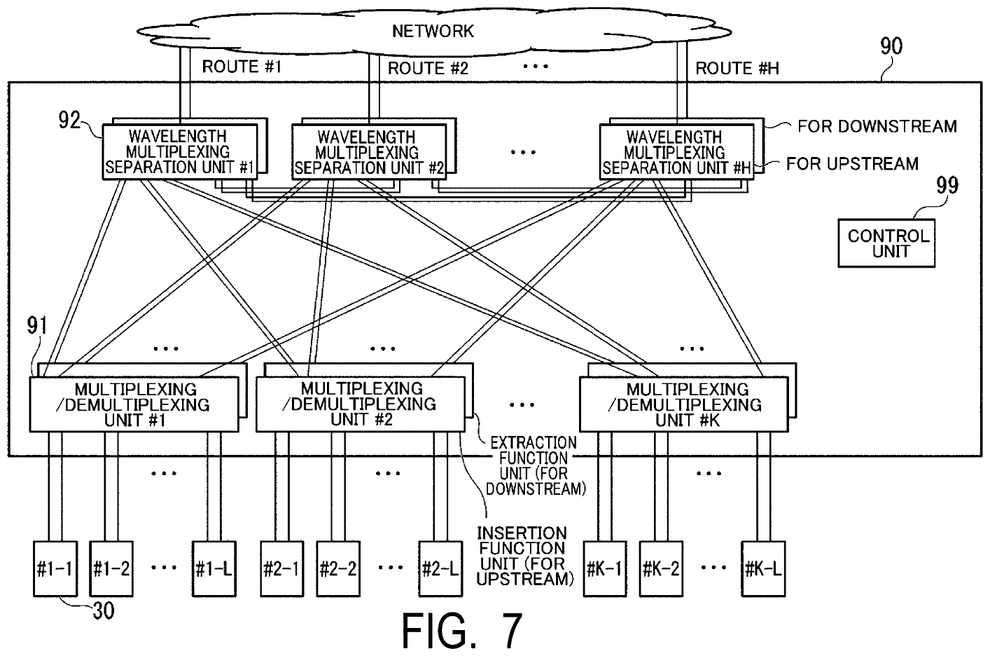

Therefore, when the number of transponder side ports of the multiplexing/demultiplexing unit 11 is the same as the number of transponder side ports of the multiplexing/demultiplexing unit 91 of the conventional optical transmission device 90 having no extraction function and insertion function shown in FIG. 7, the number of transponders 30 which can be accommodated per multiplexing/demultiplexing unit 11 decreases. Alternatively, in order to make the number of transponders 30 which can be accommodated per multiplexing/demultiplexing unit 11 equal to the number of transponders 30 which can be accommodated per multiplexing/demultiplexing unit 91 of the conventional optical transmission device 90 having no extraction machine and insertion function shown in FIG. 7, the configuration of the multiplexing/demultiplexing unit 11 needs to be enlarged to increase the number of transponder side ports.

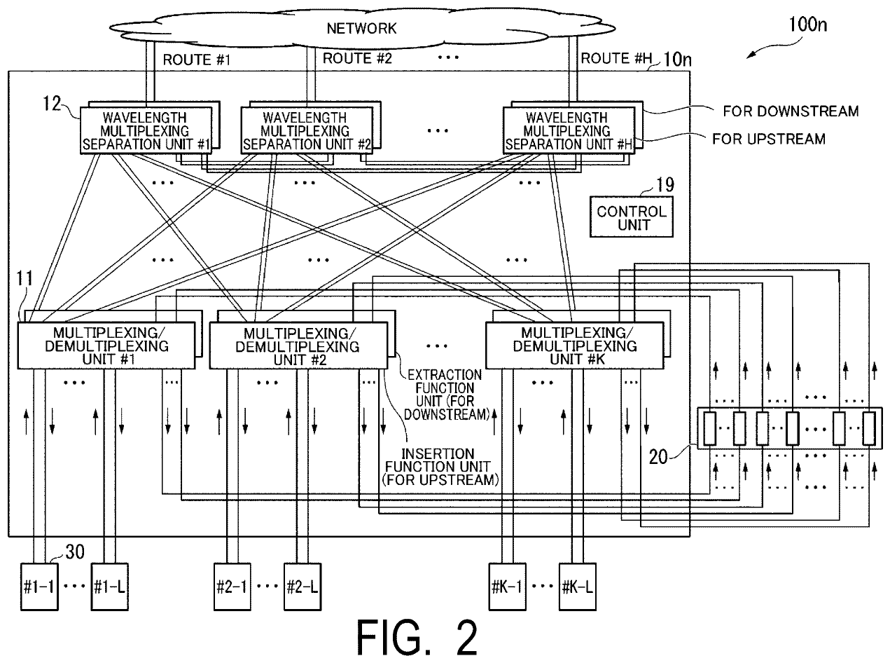

The conventional optical transmission system 100n shown in FIG. 2 is configured to realize electric processing for an optical signal in the downstream direction from an upper side (network side) to a lower side (transponder side) in the drawing.

The optical transmission device 10n is provided with a plurality of (K) multiplexing/demultiplexing units 11, a plurality of (H) wavelength multiplexing separation units 12, and a control unit 19. K and H are 2 or more integers. K and H may be the same value or different values.

The multiplexing/demultiplexing unit 11 is connected to the plurality of (L) transponders 30, the plurality of (H) wavelength multiplexing separation units 12, and the electric processing unit 20 to mutually input and output the optical signals.

For an upstream traffic from the lower side to the upper side in the drawing, the multiplexing/demultiplexing unit 11 outputs the optical signal, which is input from the transponder 30, toward the wavelength multiplexing separation unit 12. At this time, the wavelength multiplexing separation unit 12 to be an output destination is a wavelength multiplexing separation unit 12 connected to a route for accommodating an optical path in which the transponder 30 which is a transmission source of an optical signal is set as an end point. The multiplexing/demultiplexing unit 11 wavelength-multiplexes the optical signals sharing the route and outputs them.

With respect to the downstream traffic from the upper side to the lower side in the drawing, the multiplexing/demultiplexing unit 11 outputs the optical signal, which is input from the wavelength multiplexing separation unit 12, toward the transponder 30 or the electric processing unit 20. At this time, the multiplexing/demultiplexing unit 11 outputs the optical signal from a port to which the transponder 30 which is a destination of the optical signal to be output is connected. The multiplexing/demultiplexing unit 11 outputs the optical signal from the transponder side port to the electric processing unit 20, when the electric processing by the electric processing unit 20 is required for the output optical signal. With such a configuration, the extraction function is realized.

The multiplexing/demultiplexing unit 11 may be configured using, for example, an M×N multicast switch including M 1×N optical splitters/couplers and N M×1 optical switches. The multiplexing/demultiplexing unit 11 may be constituted by using, for example, WSS of M×N. The multiplexing/demultiplexing unit 11 may be configured, by using a device in which a WSS of 1×M and a WSS of 1×N are combined.

The wavelength multiplexing separation unit 12 is connected to the plurality of (K) multiplexing/demultiplexing units 11 and the plurality of (H−1) other wavelength multiplexing separation units 12 to mutually input/output the optical signals. The wavelength multiplexing separation unit 12 wavelength-multiplexes the wavelength-multiplexed optical signals which are input from the multiplexing/demultiplexing unit 11 and another wavelength multiplexing separation unit 12, and outputs the multiplexed optical signals to the network from the network side port.

The wavelength multiplexing separation unit 12 outputs an optical signal input from a network side port toward the multiplexing/demultiplexing unit 11 or another wavelength multiplexing separation unit 12. At this time, the wavelength multiplexing separation unit 12 selects the multiplexing/demultiplexing unit 11 or the wavelength multiplexing separation unit 12 to be an output destination, depending on the route of the optical path in which the transponder 30 to be a destination of the output optical signal is set as an end point. The wavelength multiplexing separation unit 12 may be constituted by, for example, using a WSS.

The control unit 19 is configured, using a processor such as a CPU and a memory. The control unit 19 may be operated when a processor executes a program. The control unit 19 controls the operations of the multiplexing/demultiplexing unit 11 and the wavelength multiplexing separation unit 12. For example, the control unit 19 may control the connection relationship between the ports in the multiplexing/demultiplexing unit 11. The control unit 19 may allocate wavelengths to the transponder 30.

The electric processing unit 20 is connected to the plurality (K) of multiplexing/demultiplexing units 11. The electric processing unit 20 performs electric processing on the optical signal that is output from the multiplexing/demultiplexing unit 11 for the downstream traffic. Specific examples of the electric processing executed by the electric processing unit 20 include reproduction relay, wavelength conversion, electric processing in a network layer, electric processing in a service layer, and the like. The electric processing unit 20 outputs the optical signal subjected to the electric processing toward the multiplexing/demultiplexing unit 11 of the input source.

In this way, the optical signal in the downstream direction which is input from the transponder side port of the multiplexing/demultiplexing unit 11 to the electric processing unit 20 is electrically processed by the electric processing unit 20, and then input to the network side port of the multiplexing/demultiplexing unit 11 which has input the optical signal to the electric processing unit 20. With such a configuration, the insertion function is realized.

The optical signal in the downstream direction which is input from the transponder side port of the multiplexing/demultiplexing unit 11 to the electric processing unit 20 may be input to the network side port of the multiplexing/demultiplexing unit 11 different from the multiplexing/demultiplexing unit 11 which has input the optical signal to the electric processing unit 20, after the electric processing is performed by the electric processing unit 20.

The multiplexing/demultiplexing unit 11 outputs the optical signal which is input from the electric processing unit 20 toward the transponder 30. At this time, the multiplexing/demultiplexing unit 11 outputs the optical signal from a port to which the transponder 30 which is a destination of the optical signal to be output is connected.

In FIG. 2, the optical signals which is input from different ports to the electric processing unit 20 are electrically processed and then output from different ports. However, the optical signal which is input from one port to the electric processing unit 20 may be output from a plurality of ports after the electric processing is executed. For example, a configuration in which a high-speed signal is separated and output as a lower-speed optical signal, or a configuration in which the same signal is copied and output from each of the plurality of ports may be adopted.

In the optical transmission system 100n shown in FIG. 2, there is a configuration in which the optical signal in the upstream direction and the optical signal in the downstream direction flow through different optical fiber core wires. However, there may be a section in which each optical signal flows through the same optical fiber core wire.

When the electric processing unit 20 converts the wavelength of the optical signal input to itself into a wavelength different from the wavelength of the optical signal output from the wavelength multiplexing separation unit 12 and outputs the optical signal, even if the electric processing unit 20 outputs the optical signal to the same multiplexing/demultiplexing unit 11 as the multiplexing/demultiplexing unit 11 to which the optical signal is input from the wavelength multiplexing separation unit 12, no collision occurs. Therefore, even in a Contention type configuration in which the multiplexing/demultiplexing unit 11 does not allow input of the optical signal of the same wavelength to different ports, the electric processing unit 20 can output the optical signal to the same multiplexing/demultiplexing unit 11 as the multiplexing/demultiplexing unit 11 to which the optical signal is input from the wavelength multiplexing separation unit 12. At this time, the wavelength of the optical signal output from the electric processing unit 20 is a wavelength different from the wavelength of the optical signal input from the wavelength multiplexing separation unit 12 to the multiplexing/demultiplexing unit 11 and the wavelength of the other optical signal input from the electric processing unit 20 to the multiplexing/demultiplexing unit 11.

In the configuration of the conventional optical transmission system 100n shown in FIG. 2, the same number of ports (hereinafter referred to as “extracting ports”) used for extraction functions as the number of optical paths distributed to the electric processing unit 20 are required to be secured on the transponder side ports of the multiplexing/demultiplexing unit 11.

Therefore, when the number of transponder side ports of the multiplexing/demultiplexing unit 11 is the same as the number of transponder side ports of the multiplexing/demultiplexing unit 91 of the conventional optical transmission device 90 having no extraction machine and insertion function, for example, shown in FIG. 7, the number of transponders 30 which can be accommodated per multiplexing/demultiplexing unit 11 decreases. Alternatively, in order to make the number of transponders 30 which can be accommodated per multiplexing/demultiplexing unit 11 equal to the number of transponders 30 which can be accommodated per multiplexing/demultiplexing unit 91 of the conventional optical transmission device 90 having no extraction machine and insertion function shown in FIG. 7, the configuration of the multiplexing/demultiplexing unit 11 needs to be enlarged to increase the number of transponder side ports.

In this way, in the configuration of the conventional optical transmission system 100m shown in FIG. 1 and the configuration of the conventional optical transmission system 100n shown in FIG. 2, when the electric processing is performed on the optical signal, there is a problem that the number of transponders 30 which can be accommodated per multiplexing/demultiplexing unit 11 decreases, or the configuration of the multiplexing/demultiplexing unit 11 needs to be enlarged. On the other hand, in the optical transmission system according to the embodiment of the present invention to be described below, the electric processing can be performed on an optical signal, without reducing the number of transponders 30 that can be accommodated per multiplexing/demultiplexing unit 11 or enlarging the configuration of the multiplexing/demultiplexing unit 11.

### First Embodiment

Hereinafter, an optical transmission system 100a according to a first embodiment of the present invention will be described with reference to the drawings.

### [Configuration of Optical Transmission System]

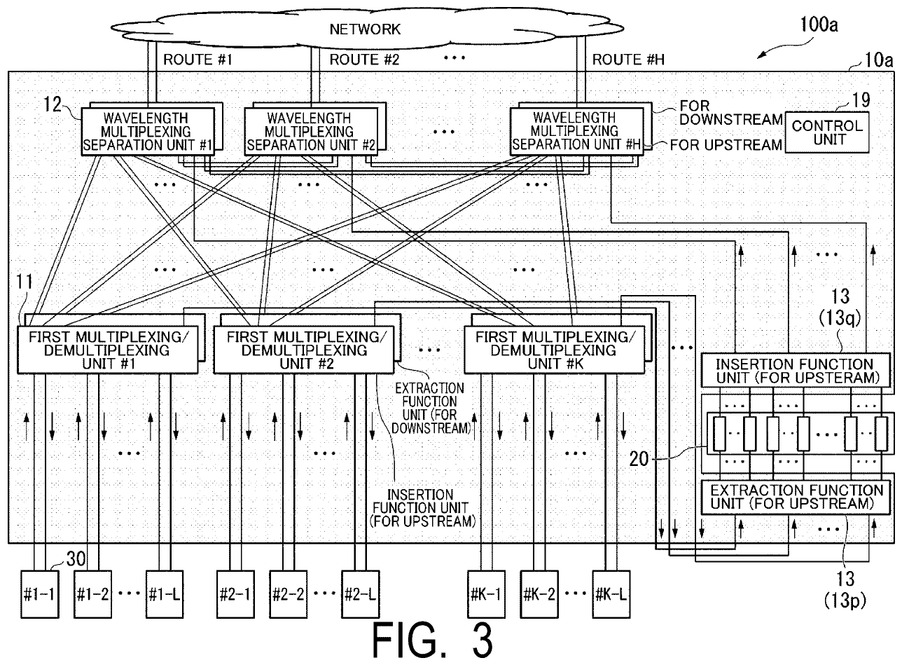

FIG. 3 is a diagram showing a configuration of an optical transmission system 100a in the first embodiment of the present invention. As shown in FIG. 3, the optical transmission system 100a includes an optical transmission device 10a and an electric processing unit 20. The optical transmission device 10a and the electric processing unit 20 are connected to mutually input and output optical signals.

The optical transmission device 10a is connected to the network and the transponder 30. The optical transmission device 10a is connected to another optical transmission device (not shown) via a network made up of optical fibers.

In FIG. 3, a network is located on the upper side of the optical transmission device 10a. When a position relatively close to the network is pointed, it is described as “network side”. A transponder 30 is located on the lower side of the optical transmission device 10a. When a position relatively close to the transponder 30 side is pointed, it is described as “transponder side”.

The optical transmission system 100a in the first embodiment shown in FIG. 3 is configured to realize electric processing for an optical signal in the upstream direction from a lower side (transponder side) to an upper side (network side) in the drawing.

As shown in FIG. 3, the optical transmission device 10a includes a plurality (K) of first multiplexing/demultiplexing units 11, a plurality (H) of wavelength multiplexing separation units 12, a second multiplexing/demultiplexing unit 13, and a control unit 19. K and H are 2 or more integers, respectively. K and H may be the same value or different values.

Further, as shown in FIG. 3, the first multiplexing/demultiplexing unit 11 includes an extraction function unit (for upstream) and an insertion function unit (for upstream). Further, as shown in FIG. 3, the second multiplexing/demultiplexing unit 13 is made up of an extraction function unit (for upstream) 13p and an insertion function unit (for upstream) 13q which are disposed to sandwich the electric processing unit 20.

The first multiplexing/demultiplexing unit 11 is connected to the plurality of (L) transponders 30 and the plurality of (H) wavelength multiplexing separation units 12 to mutually input and output the optical signals. The first multiplexing/demultiplexing unit 11 is connected to the extraction function unit (upstream) 13p to output the optical signal to the extraction function unit (upstream) 13p constituting the second multiplexing/demultiplexing unit 13.

For upstream traffic from the lower side to the upper side in the drawing, an insertion function unit (for upstream) of the first multiplexing/demultiplexing unit 11 outputs the optical signal, which is input from the transponder 30, toward the extraction function unit (for upstream) 13p constituting the wavelength multiplexing separation unit 12 or the second multiplexing/demultiplexing unit 13. At this time, the wavelength multiplexing separation unit 12 to be an output destination is a wavelength multiplexing separation unit 12 connected to a route for accommodating an optical path in which the transponder 30 which is a transmission source of an optical signal is set as an end point. The insertion function unit (for upstream) of the first multiplexing/demultiplexing unit 11 wavelength-multiplexes the optical signals sharing the route and outputs them.

The insertion function unit (for upstream) of the first multiplexing/demultiplexing unit 11 outputs the optical signal from the network side port to the extraction function unit (for upstream) 13p constituting the second multiplexing/demultiplexing unit 13, when electric processing by the electric processing unit 20 is required for the optical signal to be output. With such a configuration, the extraction function is realized.

With respect to the downstream traffic from the upper side to the lower side in the drawing, the extraction function unit (for downstream) of the first multiplexing/demultiplexing unit 11 outputs the optical signal which is input from the wavelength multiplexing separation unit 12 toward the transponder 30. At this time, the multiplexing/demultiplexing unit 11 outputs an optical signal from a port to which a transponder 30 which is a destination of the optical signal to be output is connected.

The insertion function unit (for upstream) and the extraction function unit (for upstream) of the first multiplexing/demultiplexing unit 11 may be constituted by, for example, using an M×N multicast switch including M 1×N optical splitters/couplers and N M×1 optical switches. The insertion function unit (for upstream) and the extraction function unit (for downstream) of the first multiplexing/demultiplexing unit 11 may be constituted by, for example, using a WSS of M×N. The insertion function unit (for upstream) and the extraction function unit (for downstream) of the first multiplexing/demultiplexing unit 11 may be constituted by using a device that combines WSS of 1×M and WSS of 1×N.

The insertion function unit (for upstream) and the extraction function unit (for upstream) of the first multiplexing/demultiplexing unit 11 may be constituted by combining a fiber cross connect (FXC) device and a wavelength multiplexing/demultiplexing means such as an arrayed waveguide grating (AWG) or a WSS. The FXC is constituted by using micro electro mechanical systems (MEMS) or a piezo actuator described in NPL 3. The FXC outputs light input from each port to a port that has a connection relationship set as a connection port for that port, regardless of the wavelength.

The wavelength multiplexing separation unit 12 is connected to the plurality of (K) first multiplexing/demultiplexing units 11 and the plurality of (H−1) other wavelength multiplexing separation units 12 to mutually input/output the optical signals. The wavelength multiplexing separation unit 12 is connected to an insertion function unit (upstream) 13q so that the optical signal output from the insertion function unit (upstream) 13q that constitutes the second multiplexing/demultiplexing unit 13 is input. The wavelength multiplexing separation unit 12 wavelength-multiplexes the wavelength-multiplexed optical signals which are input from the insertion function unit (for upstream) of the first multiplexing/demultiplexing unit 11, another wavelength multiplexing separation unit 12, and the second multiplexing/demultiplexing unit 13, and outputs the multiplexed optical signals to the network from the network side port.

The wavelength multiplexing separation unit 12 outputs the optical signal which is input from the network side port toward the first multiplexing/demultiplexing unit 11 or another wavelength multiplexing separation unit 12. At this time, the wavelength multiplexing separation unit 12 selects the first multiplexing/demultiplexing unit 11 or another wavelength multiplexing separation unit 12 to be an output destination, depending on the route of the optical path in which the transponder 30 to be a destination of the output optical signal is set as an end point. The wavelength multiplexing separation unit 12 may be mounted using, for example, a wavelength cross connect (WXC) constituted by a WSS.

The extraction function unit (for upstream) 13p constituting the second multiplexing/demultiplexing unit 13 is connected to the insertion function unit (for upstream) of the plurality (K) of first multiplexing/demultiplexing units 11 and the electric processing unit 20. The extraction function unit (for upstream) 13p separates the optical signal which is output by wavelength multiplexing from the network side port of the insertion function unit (for upstream) of the first multiplexing/demultiplexing unit 11 for each wavelength, and outputs it to the electric processing unit 20 for the upstream traffic.

The insertion function unit (for upstream) 13q constituting the second multiplexing/demultiplexing unit 13 is connected to the electric processing unit 20 and the plurality of (H) wavelength multiplexing separation units 12. The insertion function unit (for upstream) 13q outputs the optical signal which is output from the electric processing unit 20 to the transponder side port of the wavelength multiplexing separation unit 12 for upstream traffic. With such a configuration, the insertion function is realized.

The insertion function unit (for upstream) 13q outputs the optical signal to the wavelength multiplexing separation unit 12 connected to a route for accommodating the optical path for transmitting the optical signal. The insertion function unit (for upstream) 13q wavelength-multiplexes the optical signals sharing the route.

The same configuration as the insertion function unit (for upstream) and the extraction function unit (for downstream) of the first multiplexing/demultiplexing unit 11 can be used as the extraction function unit (for upstream) 13p and the insertion function unit (for upstream) 13q constituting the second multiplexing/demultiplexing unit 13. The second multiplexing/demultiplexing unit 13 may be constituted by combining a fiber cross connect (FXC) device and a wavelength multiplexing/demultiplexing means such as an arrayed waveguide grating (AWG) or a WSS. The FXC is constituted by using micro electro mechanical systems (MEMS) or a piezo actuator described in NPL 3. The FXC outputs an optical signal which is input from each port to a port with which a connection relationship is set as a connection port for the port, regardless of a wavelength.

The control unit 19 is constituted by a processor such as a CPU and a memory. The control unit 19 may be operated when a processor executes a program. The control unit 19 controls operations of the first multiplexing/demultiplexing unit 11, the wavelength multiplexing separation unit 12, and the second multiplexing/demultiplexing unit 13. For example, the control unit 19 may control the connection relationship between the port and the port in the first multiplexing/demultiplexing unit 11 and the second multiplexing/demultiplexing unit 13. The control unit 19 may allocate wavelengths to the transponder 30.

The electric processing unit 20 is connected to the extraction function unit (for upstream) 13p and the insertion function unit (for upstream) 13q constituting the second multiplexing/demultiplexing unit 13. The electric processing unit 20 performs the electric processing on the optical signal which is input from the extraction function unit (upstream use) 13p constituting the second multiplexing/demultiplexing unit 13 for the upstream traffic. Specific examples of the electric processing executed by the electric processing unit 20 include reproduction relay, wavelength conversion, electric processing in a network layer, electric processing in a service layer, and the like. The electric processing unit 20 outputs the optical signal subjected to the electric processing to the insertion function unit (for upstream) 13q.

In FIG. 3, the plurality of optical signals which are input to the electric processing unit 20 are output from different ports, but the plurality of input optical signals may be output from the same port after the electric processing is performed. For example, when a Muxponder function for multiplexing a plurality of signals and outputting them as a high-speed optical signal is mounted on the electric processing unit 20, the plurality of input optical signals are output from the same port.

In the optical transmission system 100a shown in FIG. 3, there is a configuration in which the optical signal in the upstream direction and the optical signal in the downstream direction flow through different optical fiber core wires. However, there may be a section in which each optical signal flows through the same optical fiber core wire.

### [Operation of Optical Transmission System]

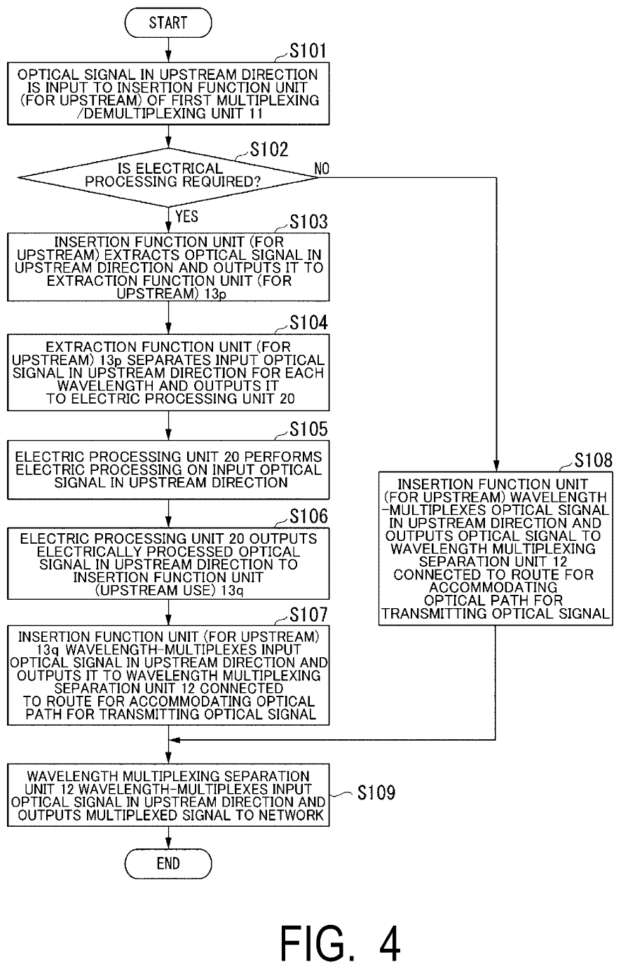

Hereinafter, an example of the operation of the optical transmission system 100a for upstream traffic will be described below. FIG. 4 is a flowchart showing the operation of the optical transmission system 100a in the first embodiment of the present invention. The operation shown by the flowchart of FIG. 4 is started, for example, when the optical signal in the upstream direction transmitted from the transponder 30 is input to the optical transmission device 10a.

The optical signal in the upstream direction transmitted from the transponder 30 is input to the insertion function unit (for upstream) of the first multiplexing/demultiplexing unit 11 (step S101). When electric processing by the electric processing unit 20 is required for the input optical signal (step S102, YES), the insertion function unit (for upstream) of the first multiplexing/demultiplexing unit 11 wavelength-multiplexes the input optical signal in the upstream direction, and outputs it from a network side port to the extraction function unit (for upstream) 13p constituting the second multiplexing/demultiplexing unit 13 (step S103).

The extraction function unit (for upstream) 13p separates the wavelength-multiplexed optical signal in the upstream direction which is input from the insertion function unit (for upstream) of the first multiplexing/demultiplexing unit 11 for each wavelength, and outputs it to the electric processing unit 20 (step S104).

The electric processing unit 20 performs electric processing on the optical signal in the upstream direction which is input from the extraction function unit (for upstream) 13p (step S105). The electric processing unit 20 outputs the electrically processed optical signal in the upstream direction to the insertion function unit (for upstream) 13q constituting the second multiplexing/demultiplexing unit 13 (step S106).

The insertion function unit (for upstream) 13q wavelength-multiplexes the optical signal in the upstream direction for each wavelength which is input from the electric processing unit 20, and outputs it to the transponder side port of the wavelength multiplexing separation unit 12 which is connected to a route for accommodating the optical path for transmitting the optical signal (step S107).

On the other hand, when electric processing by the electric processing unit 20 is not required for the optical signal in the upstream direction which is input to the insertion function unit (for upstream) of the first multiplexing/demultiplexing unit 11 (step S102, NO), the insertion function unit (for upstream) of the first multiplexing/demultiplexing unit 11 wavelength-multiplexes the input optical signal in the upstream direction, and outputs it to the transponder side port of the wavelength multiplexing separation unit 12 which is connected to the route for accommodating the optical path for transmitting the optical signal (step S108).

The wavelength multiplexing separation unit 12 wavelength-multiplexes the wavelength-multiplexed optical signal in the upstream directions which are input from the insertion function unit (upstream use) of the first multiplexing/demultiplexing unit 11, another wavelength multiplexing separation unit 12, and the insertion function unit (upstream use) 13q constituting the second multiplexing/demultiplexing unit 13 to the transponder side port. The wavelength multiplexing separation unit 12 outputs the wavelength-converted optical signal in the upstream direction from the network side port to the network (step S109).

The operation of the optical transmission system 100a shown in FIG. 4 ends as above.

As described above, the optical transmission device 10a in the first embodiment of the present invention includes the second multiplexing/demultiplexing unit 13 (extraction function unit (for upstream) 13p and insertion function unit (for upstream) 13q) disposed to sandwich the electric processing unit 20. With such a configuration, the optical transmission device 10a in the first embodiment does not need to secure an inserting port at the transponder side port of the first multiplexing/demultiplexing unit 11, for example, as in the conventional optical transmission device 10m shown in FIG. 1. Thus, the optical transmission device 10a in the first embodiment can execute the electric processing on the optical signal of the upstream traffic, without reducing the number of transponders 30 which can be accommodated per the first multiplexing/demultiplexing unit 11 or without enlarging the configuration of the first multiplexing/demultiplexing unit 11.

### Second Embodiment

Hereinafter, an optical transmission system 100b in the second embodiment of the present invention will be described.

### [Configuration of Optical Transmission System]

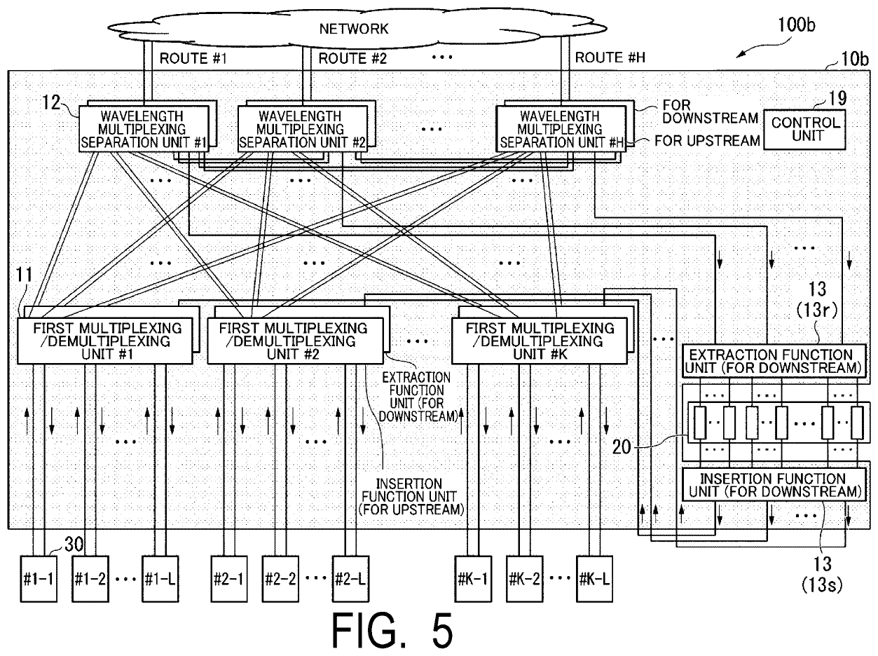

FIG. 5 is a diagram showing the configuration of an optical transmission system 100b in the second embodiment of the present invention. As shown in FIG. 5, the optical transmission system 100b includes an optical transmission device 10b and an electric processing unit 20. The optical transmission device 10b and the electric processing unit 20 are connected to mutually input and output optical signals.

The optical transmission system 100b in the second embodiment shown in FIG. 5 is configured to realize electric processing for an optical signal in the downstream direction from the upper side (network side) to the lower side (transponder side) in the drawing.

As shown in FIG. 5, the optical transmission device 10b includes a plurality (K) of first multiplexing/demultiplexing units 11, a plurality (H) of wavelength multiplexing separation units 12, a second multiplexing/demultiplexing unit 13, and a control unit 19. K and H are 2 or more integers, respectively. K and H may be the same value or different values. Further, as shown in FIG. 5, the first multiplexing/demultiplexing unit 11 includes an extraction function unit (for upstream) and an insertion function unit (for upstream). Further, as shown in FIG. 5, the second multiplexing/demultiplexing unit 13 includes an extraction function unit (for downstream) 13r and an insertion function unit (for downstream) 13s which are disposed to sandwich the electric processing unit 20.

The first multiplexing/demultiplexing unit 11 is connected to a plurality of (L) transponders 30 and a plurality of (H) wavelength multiplexing separation units 12 to mutually input and output the optical signals. The first multiplexing/demultiplexing unit 11 is connected to the insertion function unit (for downstream) 13s so that the optical signal output from the insertion function unit (for downstream) 13s constituting the second multiplexing/demultiplexing unit 13 is input.

With respect to the upstream traffic from the lower side to the upper side in the drawing, the insertion function unit (upstream) of the first multiplexing/demultiplexing unit 11 outputs the optical signal which is input from the transponder 30 toward the wavelength multiplexing separation unit 12. At this time, the wavelength multiplexing separation unit 12 to be an output destination is a wavelength multiplexing separation unit 12 which is connected to a route for accommodating an optical path in which the transponder 30 which is a transmission source of an optical signal is set as an end point. The insertion function unit (for upstream) of the first multiplexing/demultiplexing unit 11 wavelength-multiplexes optical signals sharing the route, and outputs them.

As for the downstream traffic from the upper side to the lower side in the drawing, the extraction function unit (for downstream) of the first multiplexing/demultiplexing unit 11 outputs the optical signal which is input from the insertion function unit (for downstream) 13s constituting the wavelength multiplexing separation unit 12 and the second multiplexing/demultiplexing unit 13 toward the transponder 30. At this time, the extraction function unit (for downstream) of the first multiplexing/demultiplexing unit 11 outputs an optical signal from a port to which the transponder 30 which is a destination of the optical signal to be output is connected.

The insertion function unit (for upstream) and the extraction function unit (for upstream) of the first multiplexing/demultiplexing unit 11 may be constituted by, for example, using an M×N multicast switch including M 1×N optical splitters/couplers and N M×1 optical switches. The multiplexing/demultiplexing unit 11 may be constituted by using, for example, WSS of M×N. The multiplexing/demultiplexing unit 11 may be constituted, by using a device in which a WSS of 1×M and a WSS of 1×N are combined.

The insertion function unit (for upstream) and the extraction function unit (for downstream) of the first multiplexing/demultiplexing unit 11 may be constituted by, for example, combining a device of FXC and wavelength multiplexing/demultiplexing means such as an array waveguide diffraction grating (AWG) and a WSS. The FXC is configured using MEMS and a piezo actuator described in NPL 3. The FXC outputs light which is input from each port to a port with which a connection relationship is set as a connection port for the port, regardless of the wavelength.

The wavelength multiplexing separation unit 12 is connected to a plurality of (K) first multiplexing/demultiplexing units 11 and a plurality of (H−1) other wavelength multiplexing separation units 12 to mutually input/output the optical signals. Further, the wavelength multiplexing separation unit 12 is connected to an extraction function unit (for downstream) 13r to output the optical signal toward the extraction function unit (for downstream) 13r that constitutes the second multiplexing/demultiplexing unit 13. The wavelength multiplexing separation unit 12 wavelength-multiplexes the wavelength-multiplexed optical signals which are input from the insertion function unit (for upstream) of the first multiplexing/demultiplexing unit 11 and another wavelength multiplexing separation unit 12, and outputs them to the network from the network side port.

The wavelength multiplexing separation unit 12 outputs the optical signal input from the network side port toward the insertion function unit (for upstream) of the first multiplexing/demultiplexing unit 11, another wavelength multiplexing separation unit 12, or the extraction function unit (for downstream) 13r constituting the second multiplexing/demultiplexing unit 13. At this time, the wavelength multiplexing separation unit 12 selects the first multiplexing/demultiplexing unit 11 or another wavelength multiplexing separation unit 12 to be an output destination, depending on the route of the optical path in which the transponder 30 to be a destination of the output optical signal is set as an end point.

When electric processing by the electric processing unit 20 is required for the output optical signal, the wavelength multiplexing separation unit 12 outputs the optical signal from the transponder side port to the extraction function unit (for downstream) 13r. With such a configuration, the extraction function is realized.

The wavelength multiplexing separation unit 12 may be mounted using, for example, a wavelength cross connect (WXC) made up of WSS.

The extraction function unit (for downstream) 13r constituting the second multiplexing/demultiplexing unit 13 is connected to the plurality of wavelength multiplexing separation units 12 and the electric processing unit 20. The extraction function unit (for downstream) 13r outputs the optical signal which is output by wavelength-multiplexing from the wavelength multiplexing separation unit 12 for each wavelength for downstream traffic, and outputs it to the electric processing unit 20.

The insertion function unit (for downstream) 13s constituting the second multiplexing/demultiplexing unit 13 is connected to the electric processing unit 20 and the extraction function units (for downstream) of the plurality of first multiplexing/demultiplexing units 11. The insertion function unit (for downstream) 13s outputs the optical signal, which is output from the electric processing unit 20, to the network side port of the extraction function unit (for downstream) of the first multiplexing/demultiplexing unit 11 for downstream traffic. With such a configuration, the insertion function is realized.

The insertion function unit (for downstream) 13s outputs the optical signal toward the extraction function unit (for downstream) of the first multiplexing/demultiplexing unit 11 connected to the transponder 30 which is a destination of the optical signal. The insertion function unit (for downstream) 13s wavelength-multiplexes the optical signals sharing the route.

The same configuration as the insertion function unit (for upstream) and the extraction function unit (for downstream) of the first multiplexing/demultiplexing unit 11 can be used as the extraction function unit (for downstream) 13r and the insertion function unit (for downstream) 13s constituting the second multiplexing/demultiplexing unit 13. The second multiplexing/demultiplexing unit 13 may be constituted by, for example, combining a fiber cross-connect (FXC) device and wavelength multiplexing/demultiplexing means such as an arrayed waveguide grating (AWG) or a WSS. The FXC is constituted by using micro electro mechanical systems (MEMS) or a piezo actuator described in NPL 3. The FXC outputs light which is input from each port to a port with which a connection relationship is set as a connection port for the port, regardless of wavelength.

The control unit 19 is constituted, using a processor such as a CPU and a memory. The control unit 19 may be operated when a processor executes a program. The control unit 19 controls operations of the first multiplexing/demultiplexing unit 11, the wavelength multiplexing separation unit 12, and the second multiplexing/demultiplexing unit 13. For example, the control unit 19 may control the connection relationship between the port and the port in the first multiplexing/demultiplexing unit 11 and the second multiplexing/demultiplexing unit 13. The control unit 19 may allocate wavelengths to the transponder 30.

The electric processing unit 20 is connected to the extraction function unit (for downstream) 13r and the insertion function unit (for downstream) 13s constituting the second multiplexing/demultiplexing unit 13. The electric processing unit 20 performs the electric processing on the optical signal which is input from the extraction function unit (for downstream) 13r constituting the second multiplexing/demultiplexing unit 13 for the downstream traffic. Specific examples of the electric processing executed by the electric processing unit 20 include reproduction relay, wavelength conversion, electric processing in a network layer, electric processing in a service layer, and the like. The electric processing unit 20 outputs the optical signal subjected to the electric processing to the insertion function unit (for downstream) 13s.

In FIG. 5, the optical signals which are input from different ports to the electric processing unit 20 are electrically processed and then output from different ports. However, the optical signal which is input from one port to the electric processing unit 20 may be output from a plurality of ports after the electric processing is executed. For example, a configuration in which high-speed signals are separated and each output as a lower-speed optical signal, or a configuration in which the same signal is copied and each output from a plurality of ports may be adopted.

In the optical transmission system 100b shown in FIG. 5, there is a configuration in which the optical signal in the upstream direction and the optical signal in the downstream direction flow through different optical fiber core wires. However, there may be a section in which each optical signal flows through the same optical fiber core wire.

### [Operation of Optical Transmission System]

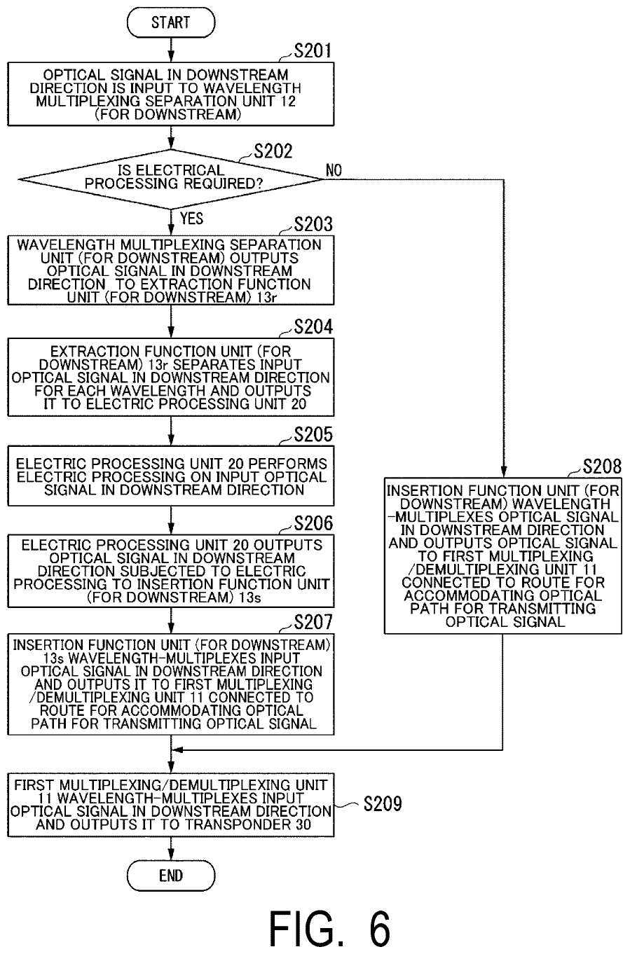

Hereinafter, an example of the operation of the optical transmission system 100b for downstream traffic will be explained. FIG. 6 is a flowchart showing the operation of the optical transmission system 100b in the second embodiment of the present invention. The operation shown by the flow chart of FIG. 6 is started, for example, when an optical signal in the downstream direction transmitted from the network side is input to the optical transmission device 10b.

The optical signal in the downstream direction transmitted from the network side is input to the wavelength multiplexing separation unit 12 (for downstream) (step S201). When electric processing by the electric processing unit 20 is required for the input optical signal in the downstream direction (step S202, YES), the wavelength multiplexing separation unit 12 (for downstream) wavelength-multiplexes the input optical signal in the downstream direction, and outputs it from the transponder side port to the extraction function unit (for downstream) 13r constituting the second multiplexing/demultiplexing unit 13 (step S203).

The extraction function unit (for downstream) 13r separates the wavelength-multiplexed optical signal in the downstream direction which is input from the wavelength multiplexing separation unit 12 (for downstream) for each wavelength, and outputs it to the electric processing unit 20 (step S204).

The electric processing unit 20 performs electric processing on the optical signal in the downstream direction which is input from the extraction function unit (for downstream) 13r (step S205). The electric processing unit 20 outputs the optical signal in the downstream direction subjected to the electric processing to the insertion function unit (for downstream) 13s constituting the second multiplexing/demultiplexing unit 13 (step S206).

The insertion function unit (for downstream) 13s wavelength-multiplexes the optical signal in the downstream direction for each wavelength which is input from the electric processing unit 20, and outputs it to the network side port of the first multiplexing/demultiplexing unit 11 which is connected to the route for accommodating an optical path for transmitting the optical signal (step S207).

On the other hand, when electric processing by the electric processing unit 20 is not required for the optical signal in the downstream direction which is input to the wavelength multiplexing separation unit 12 (for downstream) (step S202, No), the wavelength multiplexing separation unit 12 (for downstream) wavelength-multiplexes the input optical signal in the downstream direction, depending on a route of an optical path in which the transponder 30 to be destination of the optical signal is set as an end point, and outputs it to a network side port of the first multiplexing/demultiplexing unit 11 connected to the route for accommodating the optical path for transmitting the optical signal or another wavelength multiplexing separation unit 12 (for downstream) (step S208).

The first multiplexing/demultiplexing unit 11 wavelength-multiplexes the wavelength-multiplexed optical signals in the downstream direction which are input from the wavelength multiplexing separation unit 12 (for downstream) and the insertion function unit (for downstream) 13s constituting the second multiplexing/demultiplexing unit 13 to the network side port. The first multiplexing/demultiplexing unit 11 outputs the wavelength-converted optical signal in the downstream direction from the transponder side port to the transponder 30 (step S209).

The operation of the optical transmission system 100b shown in FIG. 6 ends as described above.

As described above, the optical transmission device 10b in the second embodiment of the present invention includes the second multiplexing/demultiplexing unit 13 (the extraction function unit (for downstream) 13r and the insertion function unit (for downstream) 13s) disposed to sandwich the electric processing unit 20. With such a configuration, the optical transmission device 10b in the second embodiment does not need to secure the extracting port at the transponder side port of the first multiplexing/demultiplexing unit 11, for example, as in the conventional optical transmission device 10n shown in FIG. 2. Thus, the optical transmission device 10b in the second embodiment can perform electric processing on the optical signal of the downstream traffic, without reducing the number of transponders 30 which can be accommodated per the first multiplexing/demultiplexing unit 11, or without enlarging the configuration of the first multiplexing/demultiplexing unit 11.

### Third Embodiment

The configuration of the optical transmission device 10a in the first embodiment and the configuration of the optical transmission device 10b in the second embodiment may be combined to constitute an optical transmission device 10c (not shown). With such a configuration, the extraction function and the insertion function of optical signal can be realized for both upstream traffic from the transponder 30 to the network side and downstream traffic from the network side to the transponder 30. Thus, electric processing can be performed for both the upstream signal and the downstream signal.

Thus, the optical transmission device 10c in the third embodiment of the present invention includes the second multiplexing/demultiplexing unit 13 (the extraction function unit (for upstream) 13p and the insertion function unit (for upstream) 13q, and the extraction function unit (for downstream) 13r and the insertion function unit (for downstream) 13s) which are disposed to sandwich the electric processing unit 20. With such a configuration, the optical transmission device 10c in the third embodiment does not need to secure an inserting port and the extracting port in the transponder side port of the first multiplexing/demultiplexing unit 11, for example, as in the conventional optical transmission device 10m shown in FIG. 1 and the conventional optical transmission device 10n shown in FIG. 2.

Thus, the optical transmission device 10c in the third embodiment can perform electric processing on the optical signals of the upstream traffic and the downstream traffic, without reducing the number of transponders 30 which can be accommodated per the first multiplexing/demultiplexing unit 11, or without enlarging the configuration of the first multiplexing/demultiplexing unit 11.

According to the above-described embodiment, the optical transmission device (the optical transmission apparatus) is a device that transmits an optical signal between the communication terminal device and the network, without converting the optical signal into an electric signal. For example, the optical transmission device (the optical transmission apparatus) is an optical transmission device 10a in the embodiment, and the communication terminal device is a transponder 30 in the embodiment. The optical transmission device includes a plurality of multiplexing/demultiplexing units (multiplexers/demultiplexers), a plurality of wavelength multiplexing separation units (wavelength multiplexing separator), an upstream signal demultiplexing unit (an upstream signal demultiplexer), and an upstream signal multiplexing unit (an upstream signal multiplexer). For example, the multiplexing/demultiplexing unit (the multiplexers/demultiplexers) is a first multiplexing/demultiplexing unit 11 in the embodiment, the wavelength multiplexing separation unit (the wavelength multiplexing separator) is a wavelength multiplexing separation unit 12 in the embodiment, the upstream signal demultiplexing unit (he upstream signal demultiplexer) is the extraction function unit (for upstream) 13p in the embodiment, and the upstream signal multiplexing unit (the upstream signal multiplexer) is the insertion function unit (for upstream) 13q in the embodiment.

The multiplexing/demultiplexing unit (the multiplexer/demultiplexer) inputs and outputs the optical signal to and from a communication terminal device connected to the own device. The wavelength multiplexing separation unit (the wavelength multiplexing separator) inputs and outputs the optical signal to and from a network connected to the own device. The upstream signal demultiplexing unit (the upstream signal demultiplexer) outputs the optical signal in the upstream direction which is output from the multiplexing/demultiplexing unit (the multiplexer/demultiplexer) to the electric processing unit (the electric processor) that executes predetermined electric processing on the optical signal. For example, the electric processing unit (the electric processor) is the electric processing unit 20 in the embodiment, and the optical signal of the upstream signal is the upstream traffic in the embodiment. The upstream signal multiplexing unit (the upstream signal multiplexer) outputs the optical signal in the upstream direction subjected to electric processing by the electric processing unit (the electric processor) to a predetermined wavelength multiplexing separation unit (a predetermined wavelength multiplexing separator).

The optical transmission device (the optical transmission apparatus) may further include a downstream signal demultiplexing unit (a downstream signal demultiplexer) and a downstream signal multiplexing unit. For example, the downstream signal demultiplexing unit is the extraction function unit (for downstream) 13r in the embodiment, and the downstream signal multiplexing unit is the insertion function unit (for downstream) 13s in the embodiment. The downstream signal demultiplexing unit (the downstream signal demultiplexer) outputs the optical signal in the downstream direction output from the wavelength multiplexing separation unit (the wavelength multiplexing separator) to the electric processing unit (the electric processor). For example, the optical signal in the downstream direction is the downstream traffic in the embodiment. The downstream signal multiplexing unit (the downstream signal multiplexer) outputs the optical signal in the downstream direction subjected to the electric processing by the electric processing unit (the electric processor) to a predetermined multiplexing/demultiplexing unit (a predetermined multiplexer/demultiplexer).

In the optical transmission device (the optical transmission apparatus) described above, the upstream signal demultiplexing unit (the upstream signal demultiplexer) and the upstream signal multiplexing unit (the upstream signal multiplexer) may include fiber cross connect (FXC) and wavelength multiplexing/demultiplexing means.

In the above-described optical transmission device (the optical transmission apparatus), the wavelength multiplexing separation unit (the wavelength multiplexing separator) may include a wavelength cross connect (WXC).

According to the above-described embodiment, the optical transmission device (the optical transmission apparatus) is a device that transmits the optical signal between the communication terminal device and the network, without converting the optical signal into an electric signal. For example, the optical transmission device (the optical transmission apparatus) is the optical transmission device 10b in the embodiment, and the communication terminal device is the transponder 30 in the embodiment. The optical transmission device (the optical transmission apparatus) includes a plurality of multiplexing/demultiplexing units (multiplexers/demultiplexers), a plurality of wavelength multiplexing separation unit (wavelength multiplexing separator), a downstream signal demultiplexing unit (a downstream signal demultiplexer), and a downstream signal multiplexing unit (a downstream signal multiplexer). For example, the multiplexing/demultiplexing unit (the multiplexer/demultiplexer) is the first multiplexing/demultiplexing unit 11 in the embodiment, the wavelength multiplexing separation unit (the wavelength multiplexing separator) is the wavelength multiplexing separation unit 12 in the embodiment, the downstream signal demultiplexing unit (the downstream signal demultiplexer) is the extraction function unit (for downstream) 13r in the embodiment, and the downstream signal multiplexing unit (the downstream signal multiplexer) is the insertion function unit (for downstream) 13s in the embodiment.

The multiplexing/demultiplexing unit (the multiplexer/demultiplexer) inputs and outputs the optical signal to and from the communication terminal device connected to the own device. The wavelength multiplexing separation unit (the wavelength multiplexing separator) inputs and outputs the optical signal to and from the network connected to the own device. The downstream signal demultiplexing unit (the downstream signal demultiplexer) outputs the optical signal in the downstream direction, which is output from the wavelength multiplexing separation unit (the wavelength multiplexing separator), to the electric processing unit (the electric processor) that executes predetermined electric processing on the optical signal. For example, the electric processing unit (the electric processor) is the electric processing unit 20 in the embodiment, and the optical signal of the downstream signal is the downstream traffic in the embodiment. The downstream signal multiplexing unit (the downstream signal multiplexer) outputs the optical signal in the downstream direction subjected to electric processing by the electric processing unit (the electric processor) to a predetermined multiplexing/demultiplexing unit (a predetermined multiplexer/demultiplexer).

In the optical transmission device (the optical transmission apparatus) described above, the downstream signal demultiplexing unit (the downstream signal demultiplexer) and the downstream signal multiplexing unit (the downstream signal multiplexer) may be configured to include fiber cross connect (FXC) and wavelength multiplexing/demultiplexing means.

A part or all of the optical transmission device 10a, the optical transmission device 10b, and the optical transmission device 10c of the aforementioned embodiments may be realized by a computer. In such a case, the program for realizing this function may be recorded on a computer-readable recording medium, and the program recorded on the recording medium may be read and executed by the computer system. Meanwhile, the “computer system” mentioned herein includes an OS and hardware such as peripheral equipment. In addition, the “computer-readable recording medium” refers to a portable medium such as a flexible disk, a magneto-optical disk, a ROM, or a CD-ROM or a storage device such as a hard disk that is built into the computer system.

The “computer-readable recording medium” may also include a medium that holds the program dynamically for a short period, for example a communication line in a case where the program is transmitted over a network such as the Internet or a communication line such as a telephone line, or a medium that holds the program for a fixed period, for example a volatile memory in the interior of a computer system that serves as the server or the client in the aforesaid case. In addition, the foregoing program may be for implementing some of the functions described above, may be implemented in a combination of the functions described above and a program already recorded in a computer system, or may be implemented with a programmable logic device such as a field programmable gate array (FPGA).

Although the embodiment of the present invention has been described in detail with reference to the drawings, a specific configuration is not limited to this embodiment, and design within the scope of the gist of the present invention, and the like are included.

### REFERENCE SIGNS LIST

10a, 10b, 10c, 10m, 10n Optical transmission device
11 First multiplexing/demultiplexing unit (multiplexing unit/demultiplexing unit)
12 Wavelength multiplexing separation unit
13 Second multiplexing/demultiplexing unit
13p Extraction function unit (for upstream)
13q Insertion function unit (for upstream)
13r Extraction function unit (for downstream)
13s Insertion function unit (for downstream)
19 Control unit
20 Electric processing unit
30 Transponder
90 Optical transmission device
91 Multiplexing/demultiplexing unit
92 Wavelength multiplexing/demultiplexing unit
99 Control unit
100a, 100b, 100m, 100n Optical transmission system

1. An optical transmission device which transmits an optical signal between a communication terminal device and a network, without converting the optical signal into an electric signal, the optical transmission device comprising:
a plurality of multiplexer/demultiplexers which input and output the optical signal to and from the communication terminal device connected to an own device;
a plurality of wavelength multiplexing separators which input and output the optical signal to and from a network connected to the own device;
an upstream signal demultiplexer which outputs the optical signal in an upstream direction, which is output from the multiplexer/demultiplexer, to an electric processor that executes predetermined electric processing on the optical signal; and
an upstream signal multiplexer which outputs the optical signal in the upstream direction subjected to the electric processing by the electric processor to the predetermined wavelength multiplexing separator.

2. The optical transmission device according to claim 1, further comprising:
a downstream signal demultiplexer which outputs the optical signal in the downstream direction output from the wavelength multiplexing separator to the electric processor; and
a downstream signal multiplexer which outputs the optical signal in the downstream direction subjected to the electric processing by the electric processor to the predetermined multiplexer/demultiplexer.

3. The optical transmission device according to claim 1,
wherein the upstream signal demultiplexer and the upstream signal multiplexer are configured to include a fiber cross connect and wavelength multiplexing/demultiplexing means.

4. The optical transmission device according to claim 1,
wherein the wavelength multiplexing separator is configured to include a wavelength cross connect.

5. An optical transmission device which transmits an optical signal between a communication terminal device and a network, without converting the optical signal into an electric signal, the optical transmission device comprising:
a plurality of multiplexer/demultiplexers which input and output the optical signal to and from the communication terminal device connected to an own device;
a plurality of wavelength multiplexing separators which input and output the optical signal to and from a network connected to the own device;
a downstream signal demultiplexer which outputs the optical signal in a downstream direction, which is output from the wavelength multiplexing separator, to an electric processor that executes predetermined electric processing on the optical signal; and
a downstream signal multiplexer which outputs the optical signal in the downstream direction subjected to the electric processing by the electric processor to the predetermined multiplexer/demultiplexer.

6. The optical transmission device according to claim 5,
wherein the downstream signal demultiplexer and the downstream signal multiplexer are configured to include a fiber cross connect and wavelength multiplexing/demultiplexing means.

7. An optical transmission method which transmits an optical signal between a communication terminal device and a network, without converting the optical signal into an electric signal, the optical transmission method comprising:
inputting and outputting the optical signal to and from the communication terminal device connected to an own device, by a multiplexer/demultiplexer;
inputting and outputting the optical signal to and from a network connected to the own device, by a wavelength multiplexing separator;
outputting the optical signal in an upstream direction, which is output from the multiplexer/demultiplexer, to an electric processor that executes predetermined electric processing on the optical signal, by an upstream signal demultiplexer; and
outputting the optical signal in the upstream direction subjected to the electric processing by the electric processor to the predetermined wavelength multiplexing separator, by an upstream signal multiplexer.

8. An optical transmission method which transmits an optical signal between a communication terminal device and a network, without converting the optical signal into an electric signal, the optical transmission method comprising:
inputting and outputting the optical signal to and from the communication terminal device connected to an own device, by a multiplexer/demultiplexer;
inputting and outputting the optical signal to and from a network connected to the own device, by a wavelength multiplexing separator;
outputting the optical signal in a downstream direction, which is output from the wavelength multiplexing separator, to an electric processor that executes predetermined electric processing on the optical signal, by a downstream signal demultiplexer; and
outputting the optical signal in the downstream direction subjected to the electric processing by the electric processor to the predetermined multiplexer/demultiplexer, by a downstream signal multiplexer.
